(19) United States
(12) Patent Application Publication
(10) Pub. No.: US 2020/0342019 A1
(43) Pub. Date: Oct. 29, 2020

(54) DOCUMENT SUMMARIZING APPARATUS, DOCUMENT SUMMARIZING SYSTEM, METHOD OF DOCUMENT SUMMARIZATION, AND STORING MEDIUM

(71) Applicant: SHARP KABUSHIKI KAISHA, Osaka (JP)

(72) Inventor: OSAMU MANBA, Osaka (JP)

(21) Appl. No.: 16/833,300

(22) Filed: Mar. 27, 2020

(30) Foreign Application Priority Data
Apr. 25, 2019 (JP) 2019-084294

(51) Int. Cl. G06F 16/34; G06F 16/93

(52) U.S. Cl. CPC G06F 16/345; G06F 16/93

(57) ABSTRACT

A document summarizing apparatus including: a document acquiring unit configured to acquire an input document; an extractor configured to extract, from the input document acquired by the document acquiring unit, one or more important words and one or more relevant words relating to the one or more important words; a determination unit configured to determine a risk of misunderstanding in a summary comprising the one or more important words and one or more relevant words, by referring to a list of morphemes that is obtained from the input document that has undergone morphological analysis; and an output-information generator configured to upon receiving, from the determination unit, a determination that the risk of misunderstanding equals or exceeds a predetermined value, generate information based on the determination, and output the generated information.

### BACKGROUND OF THE INVENTION

### Field of the Invention

The present invention relates to a document summarizing apparatus, a document summarizing system, a method of document summarization, and a storing medium. The present application claims priority from Japanese Application 2019-84294, filed Apr. 25, 2019, the content to which is hereby incorporated by reference into this application.

### Description of the Background Art

A technique of generating a summary of a document that has been input, has been recently developed in order to save time for reading a news article and to arrange pieces of information about the news article (c.f., Japanese Patent Application Laid-Open No. 11-282881).

Japanese Patent Application Laid-Open No. 11-282881 discloses a document summarizing apparatus that extracts important words and their relationships from a document that has been input, and that generates a summary of the document on the basis of these extracts.

The document summarizing apparatus in Japanese Patent Application Laid-Open No. 11-282881, which generates a summary containing the exact substance of texts that have been input, unfortunately tends to produce a redundant summary. To solve this problem, a summary as short as possible is desirably output. However, a shorter summary can contain a fact different from the input document.

### SUMMARY OF THE INVENTION

To solve the above problem, it is a main object of one aspect of the present invention to achieve a document summarizing apparatus that prevents, even in generating a short summary, display of a fact different from the substance of an input document.

To solve the problem, a document summarizing apparatus according to one aspect of the present invention includes the following: a document acquiring unit that acquires an input document; an extractor that extracts, from the input document acquired by the document acquiring unit, one or more important words and one or more relevant words relating to the one or more important words; a determination unit that determines a risk of misunderstanding in a summary composed of the one or more important words and one or more relevant words, by referring to a list of morphemes that is obtained from the input document that has undergone morphological analysis; and an output-information generator that upon receiving, from the determination unit, a determination that the risk of misunderstanding equals or exceeds a predetermined value, generates information based on the determination, and outputs the generated information.

To solve the problem, a method of document summarization according to another aspect of the present invention includes the following steps: acquiring an input document; extracting, from the input document acquired in the acquiring step, one or more important words and one or more relevant words relating to the one or more important words; determining a risk of misunderstanding in a summary composed of the one or more important words and one or more relevant words, by referring to a list of morphemes that is obtained from the input document that has undergone morphological analysis; and upon making, in the determining step, a determination that the risk of misunderstanding equals or exceeds a predetermined value, generating information based on the determination, and outputting the generated information.

The aspects of the present invention achieves a document summarizing apparatus that prevents, even in generating a short summary, display of a fact different from the substance of an input document.

### BRIEF DESCRIPTION OF THE DRAWINGS

FIG. 1 is a block diagram illustrating a document summarizing system according to a first preferred embodiment of the present invention;

FIG. 2 is a block diagram illustrating main components of a controller according to the first preferred embodiment of the present invention;

FIG. 3 illustrates an exemplary list of morphemes produced as a result of morphological analysis performed by a morpheme analyzer according to the first preferred embodiment of the present invention;

FIG. 4 illustrates exemplary determination patterns stored in a database according to the first preferred embodiment of the present invention;

FIG. 5 illustrates exemplary two-word summaries generated by an output-information generator according to the first preferred embodiment of the present invention;

FIG. 6 is a flowchart showing a process for document summarization that is performed in the document summarizing system according to the first preferred embodiment of the present invention;

FIG. 7 is a block diagram illustrating main components of a controller according to a second preferred embodiment of the present invention;

FIG. 8 is a flowchart showing a process for document summarization according to the second preferred embodiment of the present invention; and

FIG. 9 is a block diagram illustrating the configuration of a computer usable as a server or terminal.

### DETAILED DESCRIPTION OF THE INVENTION

### First Preferred Embodiment

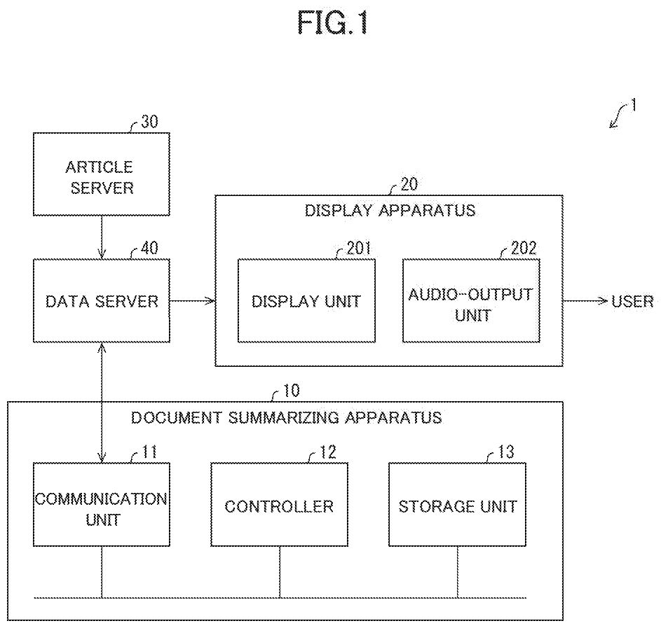

A document summarizing system 1 according to a first preferred embodiment will be described with reference to FIG. 1. FIG. 1 is a block diagram illustrating the configuration of the document summarizing system 1.

### Document Summarizing System 1

The document summarizing system 1 is a system for generating a summary from a document that has been input. As illustrated in FIG. 1, the document summarizing system 1 includes a document summarizing apparatus 10, a display apparatus 20, an article server 30, and a data server 40. The article server 30 and the data server 40 may be implemented as separate servers or as an integrated server. By way of example only, the following description addresses that the article server 30 and the data server 40 are implemented by separate servers.

### Document Summarizing Apparatus 10

As illustrated in FIG. 1, the document summarizing apparatus 10 includes a communication unit 11, a controller 12, and a storage unit 13. The document summarizing apparatus 10 generates a summary of a document that has been input. More specifically, the document summarizing apparatus 10 acquires an input document, which will be described later on, from the data server 40 via the communication unit 11, and generates a summary based on the acquired input document. The document summarizing apparatus 10 outputs the generated summary to the data server 40. Herein, the document summarizing apparatus 10 according to this preferred embodiment generates a summary consisting of N number of words. Here, N is a natural number that is equal to or greater than two, and is preferably a natural number that is equal to or greater than two and equal to or smaller than four.

The communication unit 11 is used for communication with a server on a network. Examples of the communication unit 11 usable herein include a wired LAN, a wireless LAN (e.g., Wi-Fi, registered trademark), and public radio (e.g., 3G, WiMAX, LET, and 4G).

The controller 12 is used for executing a program stored in the storage unit 13. The controller 12 executes the program to generate a summary of the input document acquired from the data server 40. The specific configuration of the controller 12 will be described later on.

The storage unit 13 stores programs, such as an OS, a device driver, middleware, and an app. Examples of the storage unit 13 usable herein include a memory (e.g., an SRAM and a flash ROM), an SD card, and a hard disk.

In this preferred embodiment, the document summarizing apparatus 10 is mounted on a server different from the data server 40. The server on which the document summarizing apparatus 10 is mounted and the data server 40 may be managed by the same business entity or by different business entities.

### Display Apparatus 20

The display apparatus 20 is used for outputting, to a user, article information and the summary, both of which are acquired from the data server 40. The display apparatus 20 is a mobile terminal for instance.

As illustrated in FIG. 1, the display apparatus 20 includes a display unit 201 and an audio-output unit 202. The display unit 201 displays the article information and summary acquired from the data server 40. The audio-output unit 202 outputs, by sound, the article information and summary acquired from the data server 40. It is noted that the display apparatus 20 according to this preferred embodiment may output, to the user, the article information and summary either by screen display using the display unit 201 or by sound using the audio-output unit 202. Alternatively, the display apparatus 20 may output the article information and summary both by screen display and by sound.

### Article Server 30

The article server 30 provides the data server 40 with article information. The article information herein is a document that is read in the data server 40. The article information includes, but not limited to, a title, texts (e.g., a heading and body) of an article, the category of the article, and key words of the article. Examples of the article information that is provided include a news article, an article for introducing a commodity product and service, and a document describing a current topic or event, a useful topic, or other topics.

### Data Server 40

The data server 40 acquires the article information from the article server 30 periodically. The data server 40 outputs the acquired article information to the document summarizing apparatus 10 as an input document. The data server 40 also acquires the summary generated, based on the provided input document, by the document summarizing apparatus 10. The data server 40 also outputs, to the display apparatus 20, the article information acquired from the article server 30, and the summary acquired from the document summarizing apparatus 10. Examples of the data server 40 herein include a news site, a stay-at-home shopping site, a company site, a recipe/trivia site, and a bulletin board.

### Controller 12

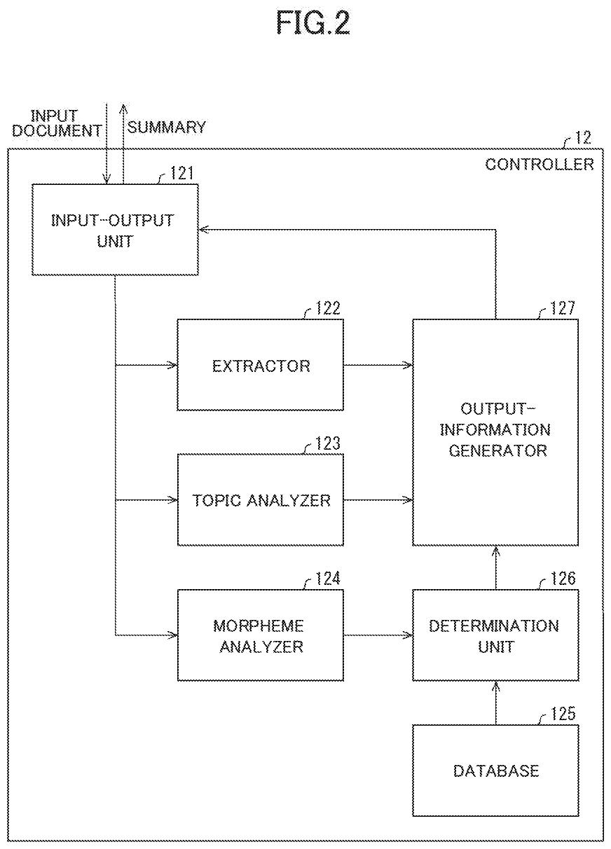

With reference to FIG. 2, the following describes the controller 12 according to the first preferred embodiment. FIG. 2 is a block diagram illustrating the configuration of the controller 12.

As illustrated in FIG. 2, the controller 12 includes an input-output unit 121 (i.e., document acquiring unit), an extractor 122, a topic analyzer 123, a morpheme analyzer 124, a database 125, a determination unit 126, and an output-information generator 127.

The input-output unit 121 acquires the input document from the data server 40 via the communication unit 11. The input-output unit 121 outputs the acquired input document to the extractor 122, topic analyzer 123, and morpheme analyzer 124. The input-output unit 121 also acquires the summary generated by the output-information generator 127, and outputs the summary to the data server 40 via the communication unit 11.

The extractor 122 summarizes the input document acquired from the input-output unit 121 into N number of words. To be specific, the extractor 122 extracts, from the input document, one or more important words and one or more relevant words relating to the one or more important words. When summarizing an input document “A-koko ni Gyakutenshori B-koko no C-senshu ga Sayonara-homuran (this sentence is in Romanized Japanese, and its English translation is as follows: Last-Minute Victory against High School A Player C of High School B Hit a Homer)” into two words for instance, the extractor 122 extracts “A-koko” as an important word, and “Gyakutenshori” as a relevant word.

When summarizing an input document “A-san ga XX-sho o Jitaishita (this sentence is in Romanized Japanese, and its English translation is as follows: Mr./Ms. A Declined XX Award)” into three words for instance, the extractor 122 extracts “A-san” as an important word, and “Jitaishita” and “XX-sho” as relevant words. In three-word summarization, although the forgoing has described an instance where the extractor 122 extracts one important word and two relevant words, the extractor 122 may extract two important words and one relevant word.

In summarization into four or more words, the extractor 122 may extract a single word for one of an important word and relevant word, and multiple words for the other of the important word and relevant word, as is the case with the three-word summarization. Alternatively, in summarization into four or more words, the extractor 122 may extract multiple important words and multiple relevant words.

The extractor 122 outputs the extracted important words and relevant words to the output-information generator 127.

How the extractor 122 extracts the summary from the input document, which can be implemented by an already-existing technique, will not be elaborated upon here.

The topic analyzer 123 performs topic-analysis on the input document acquired from the input-output unit 121, to acquire a topic word. When performing topic-analysis on an input document “◯◯-senshu ga Homuran o utta (this sentence is in Romanized Japanese, and its English translation is as follows: Player ◯◯ Hit a Homer”) for instance, the topic analyzer 123 estimates that this is a baseball article, from the characteristic words such as “Senshu” and “Homuran”, and then outputs a topic word “Baseball”.

The topic analyzer 123 outputs the topic word acquired through the topic-analysis, to the output-information generator 127.

How the topic analyzer 123 performs topic-analysis on the input document, which can be implemented by an already-existing technique, will not be elaborated upon here. The already-existing technique is LDA for instance.

The topic analyzer 123 may output, as topic words, the category and key words of the article and other items contained in the input document. For multiple article key words contained in the input document, the topic analyzer 123 may determine topic words from at least one of the following key words or in combination thereof: (1) a key word at the head of the input document, (2) a key word determined to be a proper noun as a result of morphological analysis, and (3) a key word that falls or does not fall under a particular pattern (e.g., a piece of news about XX and a subject about XX).

The morpheme analyzer 124 performs morphological analysis on the input document acquired from the input-output unit 121, to generate a list of morphemes. Here, the list of morphemes in this preferred embodiment consists of a surface form, a dictionary form, and word classes 1 to 4. Morphemes per se that appear in an analyzed sentence are put into the surface form. Dictionary forms of morphemes that have inflected forms, such as present tense and past tense (e.g., verbs), are put into the dictionary form. Word-class information including the detailed classifications of word classes of morphemes, such as a noun, a particle, and a verb, are put into word classes 1 to 4. Here, the list of morphemes according to this preferred embodiment includes specific expressions, such as a person name, a place name, an organization name, and a product name, and classification information about these specific expressions is put into word classes 3 and 4.

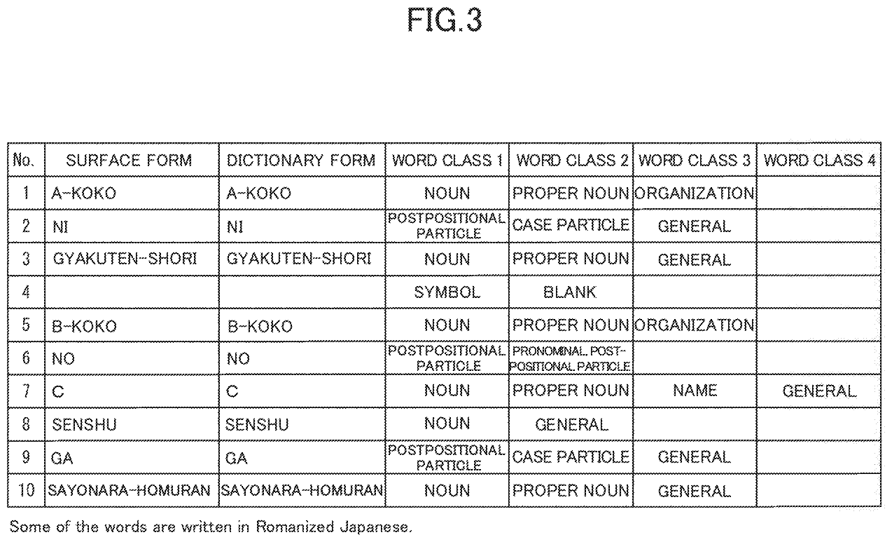

As an example of the list of morphemes that is generated, FIG. 3 is a list of morphemes generated when the morpheme analyzer 124 according to this preferred embodiment performs morphological analysis on an input document “A-koko ni Gyakuten-shori B-koko no C-senshu ga Sayonara-homuran (this sentence is in Romanized Japanese, and its English translation is as follows: Last-Minute Victory against High School A Player C of High School B Hit a Homer)”.

The morpheme analyzer 124 outputs the generated list of morphemes to the determination unit 126.

How the morpheme analyzer 124 performs morphological analysis on the input document, which can be implemented by an already-existing technique, will not be elaborated upon here. The already-existing technique is a tool, such as MeCab and JUMN++ for instance.

The database 125 stores determination patterns for determining whether the summary, generated from the important words and relevant words extracted from the input document, has a risk of showing a fact different from the substance of the input document and thus producing a misunderstanding. Such a risk of showing a fact different from the substance of the input document and thus producing a misunderstanding is hereinafter referred to as a risk of misunderstanding.

The determination patterns may be in any format that is easy to process in the determination unit 126. Examples of the format of the determination patterns include XML, JSON, a list format, and an associative array.

The determination patterns include multiple categories each provided with a risk-of-misunderstanding score. The categories include a negative category under which a document containing a negative expression falls. The categories also include an attempt category under which a document containing an attempt expression falls. The categories also include a future category under which a document containing a future expression falls. The categories also include a multi-proper-noun category under which a document containing multiple proper nouns of the same kind falls. The categories also include an another-person category under which a document containing an expression about one person and an expression about another person falls.

Each category includes multiple patterns, and the risk-of-misunderstanding score is set for each pattern. Each pattern is configured as an arrangement consisting of multiple morphemes.

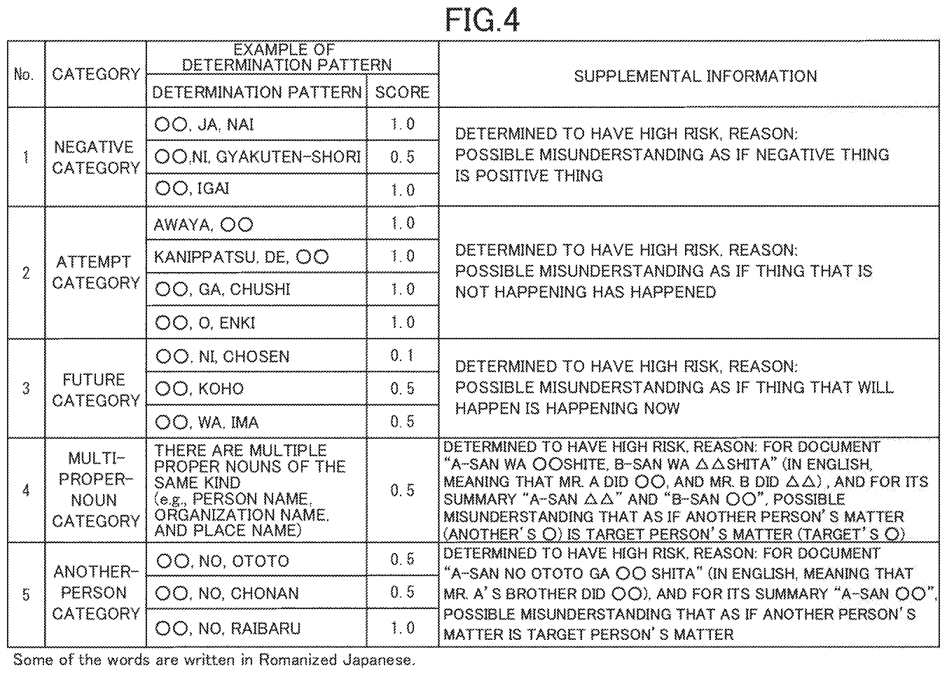

FIG. 4 illustrates exemplary determination patterns stored in the database 125.

The database 125 outputs the determination patterns to the determination unit 126.

The determination unit 126 determines a risk of misunderstanding in the summary, generated from the important words and relevant words, by referring to the list of morphemes acquired from the morpheme analyzer 124 and to the determination patterns acquired from the database 125.

The determination unit 126 compares the list of morphemes to each category, thus performing a determination process of determining whether the input document falls under the corresponding category. More specifically, the determination unit 126 performs this determination process for each pattern of the corresponding category, and adds a risk-of-misunderstanding score (i.e., determination score) of a pattern whose arranged elements match with the dictionary forms in the list of morphemes.

Here, in determination for the multi-proper-noun category, a match determination is made based on the results of analyses of the proper nouns contained in the list of morphemes. More specifically, in the determination for the multi-proper-noun category, proper nouns are counted that fall under this category, for each of the items “person name”, “organization name”, and “region name”, and a risk-of-misunderstanding score is added when there is an item where the number of counts equals or exceeds two. When there are multiple items where the number of counts equals or exceeds two, a risk-of-misunderstanding score is added by the number of items where the number of counts equals or exceeds two.

If determining that the sum of the risk-of-misunderstanding scores for the patterns that match with the list of morphemes equals or exceeds a predetermined threshold, the determination unit 126 determines that the summary, generated from the important words and relevant words, has a risk of misunderstanding. If determining that the sum of the risk-of-misunderstanding scores for the patterns that match with the list of morphemes is smaller than the predetermined threshold, the determination unit 126 determines that the summary, generated from the important words and relevant words, has no risk of misunderstanding. Here, the predetermined threshold in the determination unit 126 is set in accordance with the determination pattern acquired from the database 125.

The determination unit 126 outputs the determination result to the output-information generator 127.

The output-information generator 127 acquires the important words and relevant words from the extractor 122, and acquires the topic word from the topic analyzer 123. The output-information generator 127 also acquires the determination result from the determination unit 126, and generates an N-word summary as a summary of the input document.

More specifically, in response to a determination that the summary, generated from the important words and relevant words, has no risk of misunderstanding, the output-information generator 127 generates, as a summary, an N-word summary composed of the one or more important words and one or more relevant words. Moreover, in response to a determination that the summary, generated from the important words and relevant words, has a risk of misunderstanding, the output-information generator 127 generates an N-word summary composed of the one or more important words and a topic word.

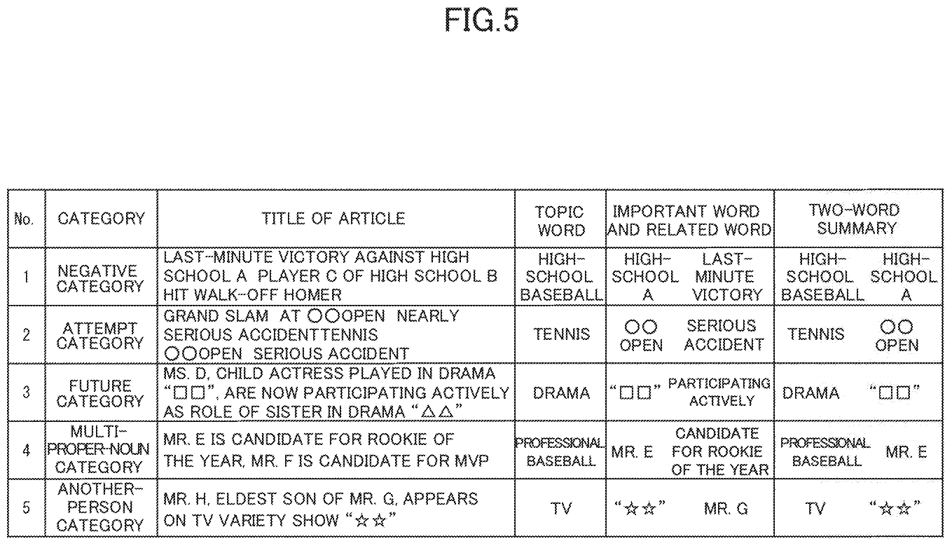

As an example of the summary generated by the output-information generator 127, FIG. 5 illustrates specific examples of a two-word summary generated by the output-information generator 127.

The output-information generator 127 outputs the generated summary to the input-output unit 121.

The patterns of each category and their risk-of-misunderstanding scores, stored in the database 125, and the predetermined threshold, set in the determination unit 126, may be set freely or may be set and adjusted by mechanical learning.

In this way, the document summarizing apparatus 10 according to this preferred embodiment can generate a summary in accordance with the result of a determination on whether a summary, generated from important words and relevant words extracted from an input document, has a risk of misunderstanding. Thus, even for an extremely short summary consisting of about N number of words, the document summarizing apparatus 10 can prevent display of a fact different from the substance of the input document.

The document summarizing apparatus 10 according to this preferred embodiment may be configured such that the database 125 stores a determination pattern for each category of the article of the input document, and outputs the determination pattern corresponding to the category of the input document to the determination unit 126.

For instance, a proper noun indicating a person name tends to appear when the input document is an entertainment- and sports-related news article. Further, a proper noun indicating an organization name tends to appear when the input document is an IT- and economy-related news article. Further, a proper noun indicating an organization name tends to appear when the input document is a food- and fashion-related news article. In this way, different categories of articles of input documents have different tendencies where a proper noun appears. For this reason, the determination pattern is preferably changed for each category of an article of an input document.

A proper noun indicating a team name (i.e., organization name) and a proper noun indicating a place name tend to appear when the input document is a sports-related news article. In some cases, a place name appears as a team name when the input document is a sports-related news article. Accordingly, the determination unit 126 may count, as the same item, the proper noun indicating the team name and the proper noun indicating the place name.

In this way, the document summarizing apparatus 10 according to this preferred embodiment is configured such that the determination unit 126 makes a determination using the determination pattern corresponding to the category of the article of the input document. This configuration enables suitable determination making on whether the summary, generated from the important words and relevant words extracted from the input document, has a risk of misunderstanding.

### Process for Text Summarization

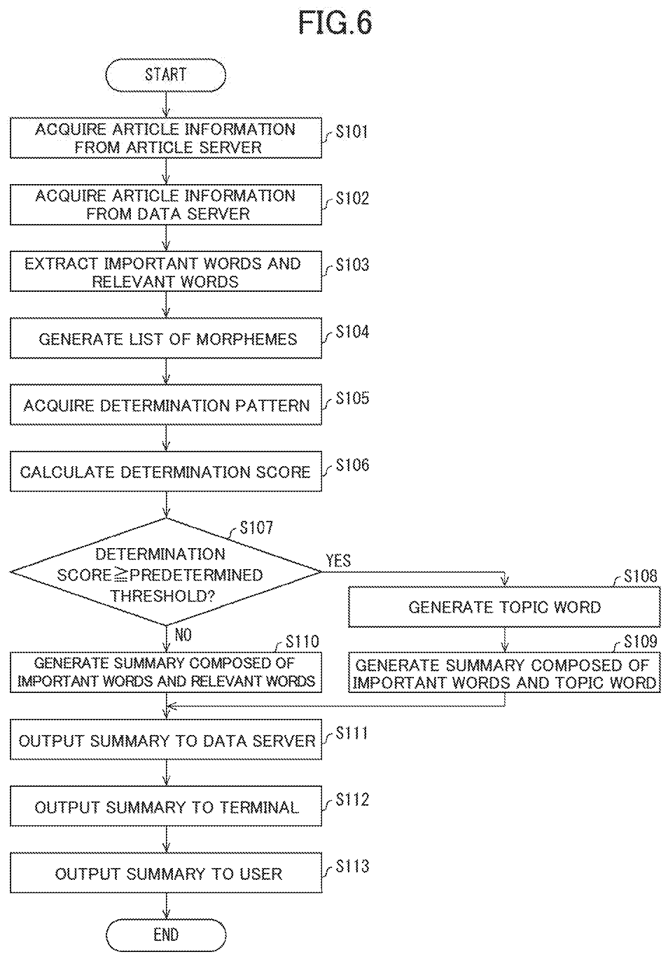

With reference to FIG. 6, the following describes a process for text summarization performed in the document summarizing system 1. FIG. 6 is a flowchart showing the operation of the document summarizing system 1.

### Step S101

The data server 40 acquires article information from the article server 30.

### Step S102

The data server 40 outputs the article information acquired from the article server 30, to the document summarizing apparatus 10 as an input document. In other words, the input-output unit 121 of the controller 12 acquires the input document from the data server 40 via the communication unit 11.

### Step S103

The extractor 122 acquires the input document from the input-output unit 121. The extractor 122 extracts, from the acquired input document, one or more important words and one or more relevant words relating to the one or more important words. The extractor 122 outputs the extracted one or more important words and extracted one or more relevant words to the output-information generator 127.

### Step S104

The morpheme analyzer 124 acquires the input document from the input-output unit 121. The morpheme analyzer 124 performs morphological analysis on the acquired input document, and generates a list of morphemes of the input document. The morpheme analyzer 124 outputs the generated list of morphemes to the determination unit 126.

### Step S105

The determination unit 126 acquires a determination pattern from the database 125.

### Step S106

The determination unit 126 determines whether the list of morphemes acquired from the morpheme analyzer 124 matches with the determination pattern acquired from the database 125, and calculates a risk-of-misunderstanding score (i.e., determination score).

### Step S107

The determination unit 126 determines whether the calculated determination score equals or exceeds a predetermined threshold.

### Step S108

If the determination unit 126 determines that the determination score equals or exceeds the predetermined threshold (i.e., if YES in Step S107), the topic analyzer 123 performs topic-analysis on the input document acquired from the input-output unit 121, and generates a topic word of the input document. The topic analyzer 123 outputs the generated topic word to the output-information generator 127.

### Step S109

The output-information generator 127 generates a summary based on the one or more important words acquired from the extractor 122 and on the topic word acquired from the topic analyzer 123. The output-information generator 127 outputs the generated summary to the input-output unit 121.

### Step S110

If the determination unit 126 determines that the determination score is smaller than the predetermined threshold (i.e., if NO in Step S107), the output-information generator 127 generates a summary based on the one or more important words and one or more relevant words acquired from the extractor 122. The output-information generator 127 outputs the generated summary to the input-output unit 121.

### Step S111

The input-output unit 121 outputs the acquired summary to the data server 40 via the communication unit 11.

### Step S112

The data server 40 outputs the acquired summary to the display apparatus 20 (i.e., terminal).

### Step S113

The display apparatus 20 outputs the acquired summary to a user.

### Second Preferred Embodiment

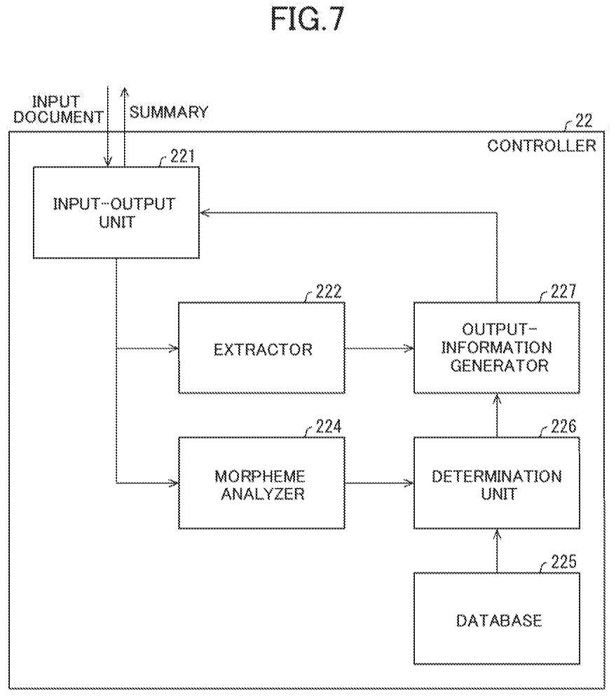

A document summarizing system according to a second preferred embodiment will be described with reference to FIG. 7. FIG. 7 is a block diagram illustrating the configuration of a controller 22 of the document summarizing system according to the second preferred embodiment. The controller 22 according to this preferred embodiment is similar to the controller 12 according to the first preferred embodiment with the exception that the topic analyzer 123 is excluded. Here, an input-output unit 221, an extractor 222, a morpheme analyzer 224, a database 225, a determination unit 226, and an output-information generator 227 respectively correspond to the input-output unit 121, the extractor 122, the morpheme analyzer 124, the database 125, the determination unit 126, and the output-information generator 127. The following describes differences between the controller 22 according to the second preferred embodiment and the controller 12 according to the first preferred embodiment.

The output-information generator 227 acquires important words and relevant words extracted by the extractor 222. The output-information generator 227 also acquires a determination result from the determination unit 226, and generates an N-word summary based on the acquired determination result as a summary of an input document.

More specifically, in response to a determination that the summary, generated from the important words and relevant words, has no risk of misunderstanding, the output-information generator 227 generates, as a summary, an N-word summary composed of the one or more important words and one or more relevant words. Moreover, in response to a determination that the summary, generated from the important words and relevant words, has a risk of misunderstanding, the output-information generator 227 generates information indicating that a summary of the input document cannot be generated.

Here, when the output-information generator 227 generates a summary, the display apparatus 20 outputs the summary to a user. In contrast, when the output-information generator 227 generates information indicating that a summary of the input document cannot be generated, the data server 40 fails to output a summary of the input document to the display apparatus 20. In other words, the display apparatus 20 fails to output the summary of the input document to the user.

### Process for Text Summarization

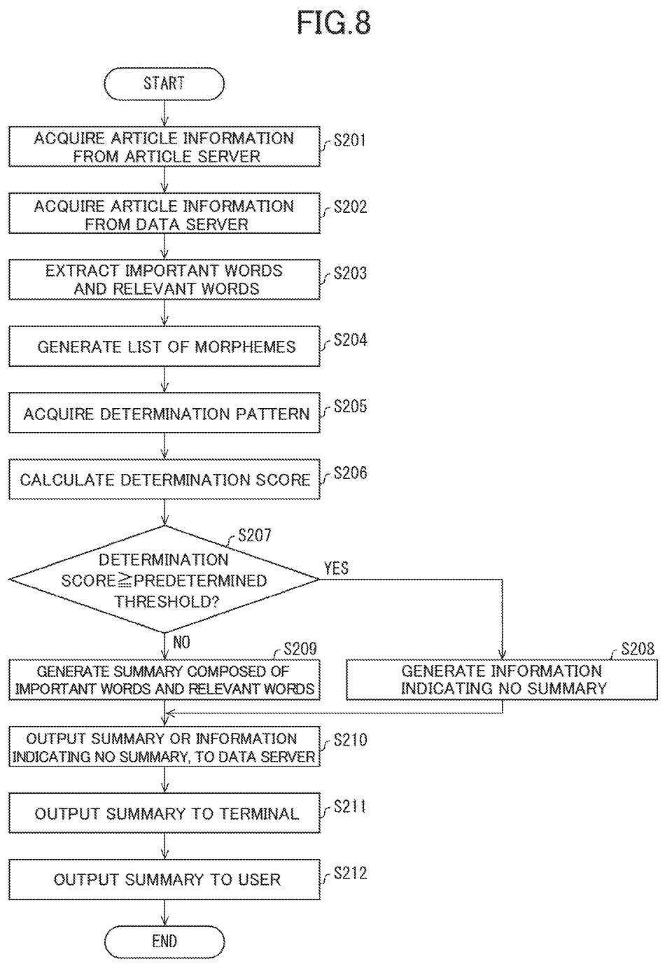

With reference to FIG. 8, the following describes a process for text summarization performed in the document summarizing system 1. FIG. 8 is a flowchart showing the operation of the document summarizing system 1.

### Step S201

The data server 40 acquires article information from the article server 30.

### Step S202

The data server 40 outputs the article information acquired from the article server 30, to the document summarizing apparatus 10 as an input document. In other words, the input-output unit 221 of the controller 22 acquires the input document from the data server 40 via the communication unit 11.

### Step S203

The extractor 222 acquires the input document from the input-output unit 221. The extractor 222 extracts, from the acquired input document, one or more important words and one or more important relevant words relating to the one or more important words. The extractor 222 outputs the extracted one or more important words and extracted one or more relevant words to the output-information generator 227.

### Step S204

The morpheme analyzer 224 acquires the input document from the input-output unit 221. The morpheme analyzer 224 performs morphological analysis on the acquired input document, and generates a list of morphemes for the input document. The morpheme analyzer 224 outputs the generated list of morphemes to the determination unit 226.

### Step S205

The determination unit 226 acquires a determination pattern from the database 225.

### Step S206

The determination unit 226 determines whether the list of morphemes acquired from the morpheme analyzer 224 matches with the determination pattern acquired from the database 225, and calculates a risk-of-misunderstanding score (i.e., determination score).

### Step S207

The determination unit 226 determines whether the calculated determination score equals or exceeds a predetermined threshold.

### Step S208

If the determination unit 226 determines that the determination score equals or exceeds the predetermined threshold (i.e., if YES in Step S207), the output-information generator 227 generates information indicating “no summary” because it cannot generate a summary from the input document.

### Step S209

If the determination unit 226 determines that the determination score is smaller than the predetermined threshold (i.e., if NO in Step S207), the output-information generator 227 generates a summary based on the one or more important words and one or more relevant words acquired from the extractor 222. The output-information generator 227 outputs the generated summary to the input-output unit 221.

### Step S210

The input-output unit 221 outputs the acquired summary or the acquired information indicating no summary, to the data server 40 via the communication unit 11.

### Step S211

The data server 40 outputs the acquired summary to the display apparatus 20 (i.e., terminal).

### Step S212

The display apparatus 20 outputs the acquired summary to a user.

### Third Preferred Embodiment

The foregoing preferred embodiments have described an instance where the document summarizing apparatus 10 and the data server 40 are individually implemented by separate servers. In some preferred embodiments, the document summarizing apparatus 10 and data server 40 may be mounted on the same server. In addition, the components of the document summarizing apparatus 10, in part or in whole, may be mounted on the display apparatus 20.

### Fourth Preferred Embodiment

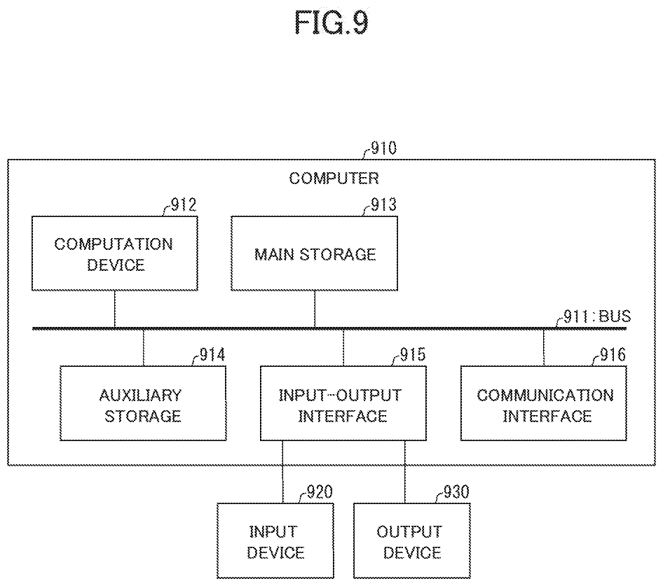

The block of the document summarizing apparatus 10 and the block of the data server 40 may be each implemented by a logic circuit (i.e., hardware) formed in, for instance, an integrated circuit (i.e., IC chip), or may be each implemented by software. For software, each of the document summarizing apparatus 10 and data server 40 can be configured with a computer (i.e., electronic computation machine) as illustrated in FIG. 9.

FIG. 9 is a block diagram illustrating the configuration of a computer 910 usable as the document summarizing apparatus 10 and as the data server 40. The computer 910 includes a computation device 912, a main storage 913, an auxiliary storage 914, an input-output interface 915, and a communication interface 916, all of which are connected to one another via a bus 911. The computation device 912, the main storage 913, and the auxiliary storage 914 may be respectively, but not limited to, a processor (e.g., central processing unit or CPU for short), a random access memory (RAM), and a hard disk drive. Connected to the input-output interface 915 are an input device 920 and an output device 930. The input device 920 is used for a user to input various pieces of information to the computer 910. Moreover, the output device 930 is used for the computer 910 to output various pieces of information to the user. The input device 920 and output device 930 may be incorporated into the computer 910 or may be connected to the computer 910 (i.e., may be externally connected). The input device 920 may be, but not limited to, a keyboard, mouse, or touch sensor. Moreover, the output device 930 may be, but not limited to, a display, printer, or speaker. Alternatively, a device may be used that serves as both the input device 920 and the output device 930, like a touch-panel with a touch sensor and display integrated therein. Further, the communication interface 916 is used for the computer 910 to communicate with an external apparatus.

The auxiliary storage 914 stores various programs for operating the computer 910 as the document summarizing apparatus 10 or as the data server 40. Further, the computation device 912 deploys the programs, stored in the auxiliary storage 914, onto the main storage 913, and then executes commands contained in the programs to operate the computer 910 as each unit that is included in the document summarizing apparatus 10 or data server 40. It is noted that the auxiliary storage 914 includes a recording medium that records information, such as programs. This recording medium is a non-transitory computer-readable tangible medium, and may be, but not limited to, a tape, disk, card, semiconductor memory, or programmable logic circuit. A computer capable of executing the programs stored in the recording medium without deploying them onto the main storage 913 does not have to include the main storage 913. It is noted that referring to each of the aforementioned devices (i.e., computation device 912, main storage 913, auxiliary storage 914, input-output interface 915, communication interface 916, input device 920, and output device 930), a single device or multiple devices may be provided.

The aforementioned programs may be acquired from the outside of the computer 910, and in this case, may be acquired via any transmission medium (e.g., a communication network and a broadcast wave). One aspect of the present invention can be implemented in the form of a data signal embodied by electronic transmission of these programs and embedded in a carrier wave.

### Summary

A document summarizing apparatus according to a first aspect of the present invention includes the following: a document acquiring unit that acquires an input document; an extractor that extracts, from the input document acquired by the document acquiring unit, one or more important words and one or more relevant words relating to the one or more important words; a determination unit that determines a risk of misunderstanding in a summary composed of the one or more important words and one or more relevant words, by referring to a list of morphemes that is obtained from the input document that has undergone morphological analysis; and an output-information generator that upon receiving, from the determination unit, a determination that the risk of misunderstanding equals or exceeds a predetermined value, generates information based on the determination, and outputs the generated information.

When the summary, composed of the one or more important words and one or more relevant words, can be different from the substance of the input document, the aforementioned configuration enables information to be output accordingly. This prevents display of a fact different from the substance of the input document.

A document summarizing apparatus according to a second aspect of the present invention may be configured, in the first aspect, such that upon receiving, from the determination unit, a determination that the risk of misunderstanding equals or exceeds the predetermined value, the output-information generator generates a summary using a topic word and the one or more important words, and outputs the generated summary, the topic word being obtained from the input document that has undergone topic-analysis.

When the summary, composed of the one or more important words and one or more relevant words, can be different from the substance of the input document, the aforementioned configuration enables the summary to be generated using the topic word and one or more important words of the input document. This prevents display of a fact different from the substance of the input document.

A document summarizing apparatus according to a third aspect of the present invention may be configured, in the first aspect, such that upon receiving, from the determination unit, a determination that the risk of misunderstanding equals or exceeds the predetermined value, the output-information generator outputs information indicating that a summary cannot be generated from the input document.

When the summary, composed of the one or more important words and one or more relevant words, can be different from the substance of the input document, the aforementioned configuration enables generation of the information indicating that a summary cannot be generated from the input document. This prevents display of a fact different from the substance of the input document.

A document summarizing apparatus according to a fourth aspect of the present invention may be configured, in any of the first to third aspects, such that with regard to a plurality of individual categories each provided with a risk-of-misunderstanding score, the determination unit performs a determination process of determining whether the input document falls under the corresponding category. In addition, the determination unit determines the risk of misunderstanding using the sum of the risk-of-misunderstanding scores for categories under which the input document is determined to fall.

The aforementioned configuration enables suitable determination making on whether the summary, composed of the one or more important words and one or more relevant words, can be different from the substance of the input document.

A document summarizing apparatus according to a fifth aspect of the present invention may be configured, in the fourth aspect, such that each of the plurality of categories includes a plurality of patterns, that the risk-of-misunderstanding score is set for each of the plurality of patterns, and that the determination unit performs the determination process for each of the plurality of patterns.

The aforementioned configuration enables suitable determination making on whether the summary, composed of the one or more important words and one or more relevant words, can be different from the substance of the input document.

A document summarizing apparatus according to a sixth aspect of the present invention may be configured, in the fourth or fifth aspect, such that the plurality of categories include at least one of a category for a document containing a negative expression, a category for a document containing an attempt expression, and a category for a document containing a future expression.

The aforementioned configuration enables suitable determination making on whether the summary, composed of the one or more important words and one or more relevant words, can be different from the substance of the input document.

A document summarizing apparatus according to a seventh aspect of the present invention is configured, in any of the fourth to sixth aspects, such that the plurality of categories include at least one of a category for a document containing a plurality of proper nouns of the same kind, and a category for a document containing an expression about one person and an expression about another person.

The aforementioned configuration enables suitable determination making on whether the summary, composed of the one or more important words and one or more relevant words, can be different from the substance of the input document.

The document summarizing system 1 according to an eight aspect of the present invention includes the document summarizing apparatus according to any of the first to seventh aspects, and a display apparatus. The display apparatus includes a display unit that displays the information generated by the output-information generator.

When the summary, composed of the one or more important words and one or more relevant words, can be different from the substance of the input document, the aforementioned configuration enables information to be output accordingly. This prevents display of a fact different from the substance of the input document.

A method of document summarization according to a ninth aspect of the present invention includes the following steps: acquiring an input document; extracting, from the input document acquired in the acquiring step, one or more important words and one or more relevant words relating to the one or more important words; determining a risk of misunderstanding in a summary composed of the one or more important words and one or more relevant words, by referring to a list of morphemes that is obtained from the input document that has undergone morphological analysis; and upon making, in the determination step, a determination that the risk of misunderstanding equals or exceeds a predetermined value, generating information based on the determination, and outputting the generated information.

When the summary, composed of the one or more important words and one or more relevant words, can be different from the substance of the input document, the aforementioned configuration enables information to be output accordingly. This prevents display of a fact different from the substance of the input document.

Each of the document summarizing apparatuses according to the first to seventh aspects of the present invention may be implemented by a computer. In this case, the present invention encompasses a computer-readable storing medium as well that stores a control program for implementing the document summarizing apparatus using a computer that operates as each component (herein, software element) of the document summarizing apparatus.

The present invention is not limited to the aforementioned preferred embodiments, and can be thus modified in various ways within the scope of the claims. The present invention encompasses a preferred embodiment obtained in combination, as necessary, with the technical means disclosed in the respective preferred embodiments. Furthermore, combining the technical means disclosed in the respective preferred embodiments can form a new technical feature.

What is claimed is:

1. A document summarizing apparatus comprising:
a document acquiring unit configured to acquire an input document;
an extractor configured to extract, from the input document acquired by the document acquiring unit, one or more important words and one or more relevant words relating to the one or more important words;
a determination unit configured to determine a risk of misunderstanding in a summary comprising the one or more important words and one or more relevant words, by referring to a list of morphemes that is obtained from the input document that has undergone morphological analysis; and
an output-information generator configured to upon receiving, from the determination unit, a determination that the risk of misunderstanding equals or exceeds a predetermined value, generate information based on the determination, and output the generated information.

2. The document summarizing apparatus according to claim 1, wherein upon receiving, from the determination unit, a determination that the risk of misunderstanding equals or exceeds the predetermined value, the output-information generator generates a summary using a topic word and the one or more important words, and outputs the generated summary, the topic word being obtained from the input document that has undergone topic-analysis.

3. The document summarizing apparatus according to claim 1, wherein upon receiving, from the determination unit, a determination that the risk of misunderstanding equals or exceeds the predetermined value, the output-information generator outputs information indicating that a summary cannot be generated from the input document.

4. The document summarizing apparatus according to claim 1, wherein
with regard to a plurality of individual categories each provided with a risk-of-misunderstanding score, the determination unit performs a determination process of determining whether the input document falls under the corresponding category, and
the determination unit determines the risk of misunderstanding using a sum of the risk-of-misunderstanding scores for categories under which the input document is determined to fall.

5. The document summarizing apparatus according to claim 4, wherein
each of the plurality of categories comprises a plurality of patterns,
the risk-of-misunderstanding score is set for each of the plurality of patterns, and
the determination unit performs the determination process for each of the plurality of patterns.

6. The document summarizing apparatus according to claim 4, wherein the plurality of categories comprise at least one of a category for a document containing a negative expression, a category for a document containing an attempt expression, and a category for a document containing a future expression.

7. The document summarizing apparatus according to claim 4, wherein the plurality of categories comprise at least one of a category for a document containing a plurality of proper nouns of the same kind, and a category for a document containing an expression about one person and an expression about another person.

8. A document summarizing system comprising:
the document summarizing apparatus according to claim 1; and
a display apparatus,
wherein the display apparatus comprises a display unit configured to display the information generated by the output-information generator.

9. A method of document summarization, comprising the steps of:
acquiring an input document;
extracting, from the input document acquired in the acquiring step, one or more important words and one or more relevant words relating to the one or more important words;
determining a risk of misunderstanding in a summary comprising the one or more important words and one or more relevant words, by referring to a list of morphemes that is obtained from the input document that has undergone morphological analysis; and
upon making, in the determining step, a determination that the risk of misunderstanding equals or exceeds a predetermined value, generating information based on the determination, and outputting the generated information.

10. A computer-readable storing medium that stores a program for operating a computer as the document summarizing apparatus according to claim 1, the program being used for operating the computer as the document acquiring unit, as the extractor, as the determination unit, and as the output-information generator.
